(19) United States
(12) Patent Application Publication
(10) Pub. No.: US 2014/0240226 A1
(43) Pub. Date: Aug. 28, 2014

(54) User Interface Apparatus

(71) Applicant: Robert Bosch GmbH, Stuttgart (DE)

(72) Inventor: Jens Faenger, Santa Clara, CA (US)

(73) Assignee: Robert Bosch GmbH, Stuttgart (DE)

(21) Appl. No.: 14/190,420

(22) Filed: Feb. 26, 2014

Related U.S. Application Data
(60) Provisional application No. 61/769,794, filed on Feb. 27, 2013.

(51) Int. Cl. G06F 3/01; G02B 27/01

(52) U.S. Cl. CPC G06F 3/011; G02B 27/017
USPC 345/156; 345/8

(57) ABSTRACT

A user interface apparatus includes a support structure, a display, a memory, and a processor. The support structure is configured to be supported on the head of a user. The display is supported by the support structure. The memory is supported by the support structure and includes program instructions. The processor is supported by the support structure and is operably connected to the display and to the memory. The processor is configured to execute the program instructions to (i) establish a communication link with a configurable device, (ii) receive interface data from the configurable device, (iii) generate optimized display data using the received interface data, (iv) render the optimized display data on the display, (v) receive a user selection of the rendered optimized display data, and (vi) transmit a control signal to the configurable device based upon the received user selection.

This application claims the benefit of priority of U.S. provisional application Ser. No. 61/769,794, filed Feb. 27, 2013, the disclosure of which is herein incorporated by reference in its entirety.

### FIELD

This disclosure relates to user interfaces for devices, and particularly to a user interface apparatus that is operable with a configurable device.

### BACKGROUND

Many devices that people interact with on a daily basis include some type of user interface. For example, a household microwave oven typically includes a display screen and a keypad. The typical display screen is capable of displaying approximately seven characters of text and/or numbers. The keypad is used to make selections that control operation of the device, such as selecting a cook time, a cook temperature, or configuring the microwave for an advanced cooking operation.

When using a device such as the exemplary microwave oven, the selections that the user makes with the keypad are displayed on the display screen. The characters that are displayed, however, are often either cryptic abbreviations or a few characters of scrolling text.

Most users consider using the keypad to program the microwave oven for one of the advanced operations time consuming and tedious. For example, one specific advanced cooking operation includes configuring the microwave oven to defrost a beef roast that weighs about three pounds and is presently frozen. To configure the microwave oven to perform the above advanced cooking operation, the user navigates through at least four submenus only one of which is displayed at a time with approximately seven characters or less. The result is often that the advanced cooking operations of the device go unused, because it is too difficult and tedious to configure the device.

The limitations of user interfaces extend beyond the kitchen and into the workplace. For example, in the healthcare field there are many devices that are configured for operation by nurses, doctors, and other practitioners. These devices typically include some sort of user interface for controlling operation of the device. The user interface, however, typically suffers from the same or similar limitations of the above-described microwave oven display screen and keypad. Furthermore, each different type of device typically has a different type of user interface, which further prevents practitioners from efficiently and easily using these devices.

Accordingly, it is desirable to provide a user interface apparatus for controlling multiple devices across numerous platforms that is easy to operate and understand.

### SUMMARY

According to an exemplary embodiment of the disclosure, a user interface apparatus includes a support structure, a display, a memory, and a processor. The support structure is configured to be supported on the head of a user. The display is supported by the support structure. The memory is supported by the support structure and includes program instructions. The processor is supported by the support structure and is operably connected to the display and to the memory. The processor is configured to execute the program instructions to (i) establish a communication link with a configurable device, (ii) receive interface data from the configurable device, (iii) generate optimized display data using the received interface data, (iv) render the optimized display data on the display, (v) receive a user selection of the rendered optimized display data, and (vi) transmit a control signal to the configurable device based upon the received user selection.

According to another exemplary embodiment of the disclosure, a method of configuring a device includes supporting a user interface apparatus on the head of a user, establishing a communication link with a configurable device using a processor supported by the user interface apparatus, and receiving through the communications link interface data from the configurable device. The method further includes generating optimized display data with the processor using the received interface data, rendering the optimized display data on the display using the camera, receiving with an I/O device supported by the user interface apparatus a user selection of the rendered optimized display data, and transmitting a control signal to the configurable device from the user interface apparatus based upon the received user selection.

### BRIEF DESCRIPTION OF THE FIGURES

The above-described features and advantages, as well as others, should become more readily apparent to those of ordinary skill in the art by reference to the following detailed description and the accompanying figures in which:

FIG. 1 is block diagram showing a user interface apparatus, as described herein, positioned in a room that includes numerous configurable devices;

FIG. 2 is a perspective view of one embodiment of the user interface apparatus of FIG. 1, which includes an electronic system and a pair of lenses;

FIG. 3 is a block diagram of the electronic system of the user interface apparatus of FIG. 1;

FIG. 4 is a flowchart illustrating an exemplary mode of operation of the user interface apparatus of FIG. 1; and

FIG. 5 is a block diagram of one the lenses of the interface apparatus of FIG. 1 showing one of the configurable devices of FIG. 1 therethrough.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

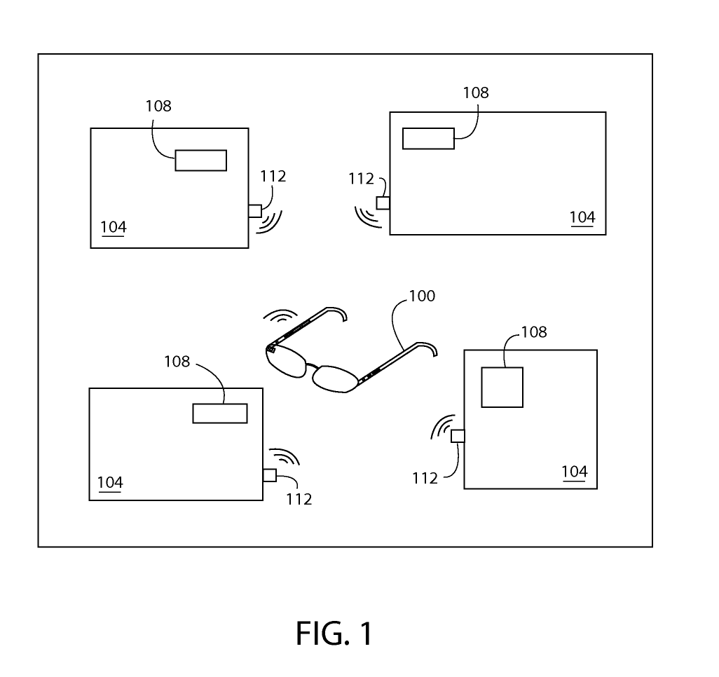

With reference to FIG. 1, a user interface apparatus 100 is positioned near four configurable devices 104. Each configurable device 104 includes a user interface 108 configured to display interface data and a wireless transceiver 112. The interface apparatus 100 is configured to wirelessly connect/link to the devices 104 and to operate as an augmented user interface for a selected one of the devices.

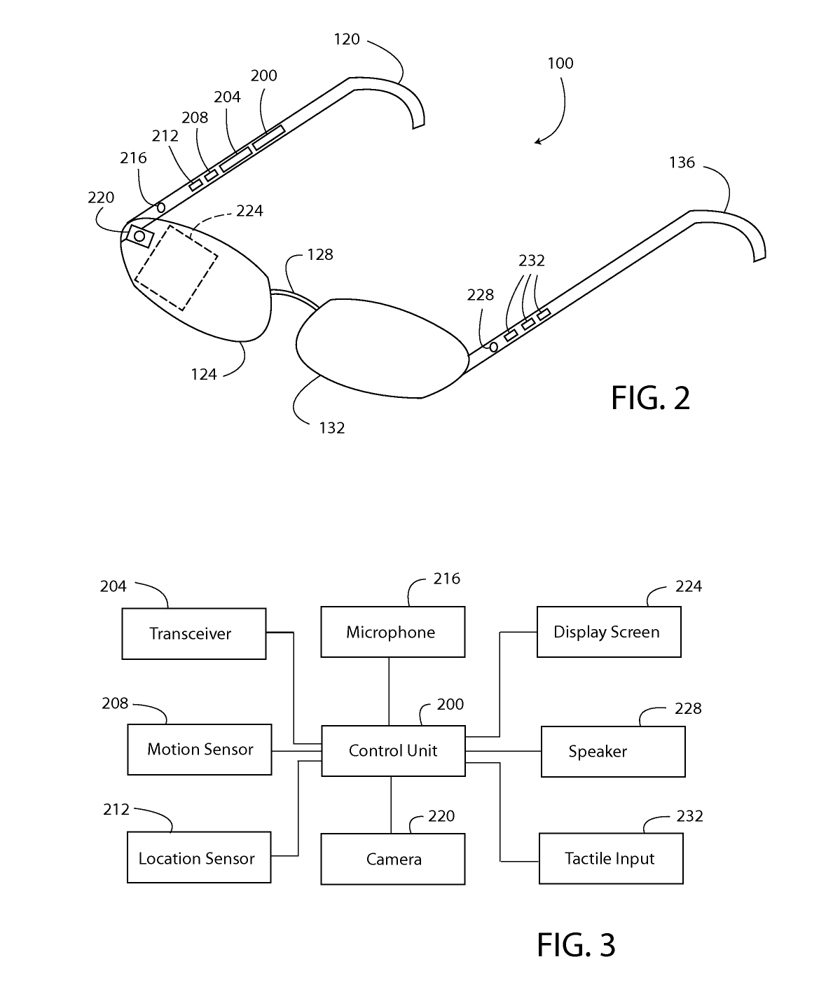

As shown in FIG. 2, the interface apparatus 100, which is also referred to herein as a support structure, includes a pair of eyeglasses, for example, that are wearable in the typical manner on the head of a user. The interface apparatus 100 includes a right temple 120, a right lens 124, a bridge structure 128, a left lens 132, and a left temple 136. The right temple 120 is pivotably coupled to the right lens 124 for movement between an open position (shown in FIG. 2) and a closed position (not shown).

The right lens 124 is fixedly connected to the bridge structure 128. In one embodiment, the lens 124 is a clear lens that does not provide vision correction. The lens 124 is formed from high strength plastic and offers protection from debris and the like. In another embodiment, the lens 124 is a prescription lens that offers vision correction. In yet another embodiment, the lens 124 is darkened, tinted, or colored to offer protection to the user from high levels of visible light and ultraviolet light. In a further embodiment, the lens 124 includes any of the above features and also is formed from a high strength material so as to function as safety glasses or safety goggles.

The bridge structure 128 is fixedly connected to the left lens 132. The bridge structure 128 is a conduit that enables electrical leads to pass from the right temple 120 and the right lens 124 to the left lens 132 and the left temple 136.

The left lens 132 is pivotably coupled to the left temple 136. In one embodiment, the lens 132 is a clear lens that does not provide vision correction. The lens 132 is formed from high strength plastic and offers protection from debris and the like. In another embodiment the lens 132 is a prescription lens that offers vision correction. In yet another embodiment, the lens 132 is darkened, tinted, or colored to offer protection to the user from high levels of visible light and ultraviolet light. In a further embodiment, the lens 132 includes any of the above features and also is formed from a high strength material so as to function as safety glasses or safety goggles.

The left temple 136 is configured for movement between an open position (shown in FIG. 2) and a closed position (not shown).

As shown in FIG. 3, the interface apparatus 100 includes a transceiver 204, a motion sensor 208, a location sensor 212, a microphone 216, a camera 220, a display screen 224, a speaker 228, and tactile inputs 232 each of which is connected to a control unit 200. The control unit 200 is an electronic unit that is supported by the support structure on the right temple 120. The control unit 200 is configured to control operation of the interface apparatus 100. The control unit 200 includes at least a processor and a memory having program instructions. The processor of the control unit 200 is operably connected to the memory and to the display screen 224. Furthermore, the processor of the control unit 200 is configured to execute the program instructions for operating the components connected thereto. A power supply (not shown) supplies electrical power to the interface apparatus 100 and is typically provided as a battery. In another embodiment, the control unit 200 is located in the left temple 136 or the bridge structure 128.

The transceiver 204 is located on the right temple 120 and is electrically coupled to the control unit 200. The transceiver 204 is a wireless input/output device that connects the interface apparatus 100 to the transceiver 112 of one or more of the devices 104. When the transceiver 204 is connected to the transceiver 112, electronic data are transmittable between the interface apparatus 100 and the device 104 it is connected to. In at least one embodiment, the transceiver 204 and the transceiver 112 operate according to the Bluetooth standard, the IEEE 802.11 standard, sometimes referred to as Wi-Fi, and/or a near field communication protocol. In another embodiment, the transceivers 112, 204 use any wireless communication standard as desired by those of ordinary skill in the art. Also, in a further embodiment, the transceiver 204 is located in the left temple 136 or the bridge structure 128.

The motion sensor 208 is supported by the support structure on the right temple 120, and is electrically coupled to the control unit 200. The motion sensor 208 is a three axis accelerometer that generates electronic motion data. By executing the program instructions, the control unit 200 uses the electronic motion data to determine the orientation of the interface apparatus 100 in three dimensional space and/or to recognize selected body movements/gestures of the user wearing the interface apparatus 100. In another embodiment, the motion sensor 208 is provided as any other motion sensor as desired by those of ordinary skill in the art. Additionally, in another embodiment, the motion sensor 208 is located in the left temple 136 or the bridge structure 128.

The location sensor 212 is supported by the support structure on the right temple 120, and is electrically coupled to the control unit 200. In one embodiment, the location sensor 212 utilizes signals from the global position system (“GPS”) to determine the location of the interface apparatus 100 and its proximity to the devices 104, which may have a known location. In another embodiment, the location sensor 212 is located in the left temple 136 or the bridge structure 218.

In one embodiment, the location sensor 212 is configured as I/O device that is configured to receive a user selection. For example, the control unit 200 may be configured to detect a selected location of the interface apparatus 100 from the data generated by the location sensor 212.

The microphone 216 is supported by the support structure on the right temple 120. The microphone 216 is configured to generate data representative of sounds near the interface apparatus 100. In use, the microphone 216 enables a user to control operation of the interface apparatus 100 and the device 104 to which the interface apparatus is connected, simply by speaking. Additionally, the operation of the interface apparatus 100 is controllable by sounds produced by the devices 104. In particular, the processor of the control unit 200 is configured to execute the program instructions to detect a selected sound detected by the microphone 216. The microphone 216 is any microphone as desired by those ordinary skill in the art. In another embodiment, the microphone 216 is located in the bridge structure 128 or the left temple 136.

In one embodiment, the microphone is configured as I/O device that is configured to receive a user selection. For example, the control unit 200 may be configured to detect a selected sound from the data generated by the microphone 216.

The camera 220 is supported by the support structure on the right lens 124. The camera 220 is a color camera that generates image data representative of a field of view of the camera 220. In particular, the camera 220 generates image data representative of the area in front interface apparatus 100 in the region where a wearer of the interface apparatus is looking. In another embodiment, the camera 220 is located on the left lens 132 or the bridge structure 128. The camera 220 is any camera as desired by those ordinary skill in the art.

In one embodiment, the camera 220 is configured as I/O device that is configured to receive a user selection. For example, the control unit 200 may be configured to detect a selected movement of the user from the image data generated by the camera 220.

The display screen 224, which is also referred to herein as a display, is a see-through display that is supported by the support structure on the right lens 124. In particular, the display screen 224 is a transparent display of organic light emitting diodes (“OLED”). The OLEDs are arranged in an array of approximately 500×500. The display screen 224 is electrically coupled to the control unit 200 and is configured to display a graphical user interface that is used to control a selected one of the devices 104. Since the display screen 224 is transparent, the user is able to see the display while still being able to see through the lens 124. This arrangement is typically referred to as “augmented reality” in which the image(s) on the display screen are overlaid onto the objects seen through the lens 124. In another embodiment, the display screen 224 is connected to the left lens 132. In yet another embodiment, the interface apparatus 100 includes a display screen 224 connected to the right lens 124 and another display screen connected to the left lens 132.

The speaker 228 is supported on the support structure on the left temple 136 and is electrically coupled to the control unit 200. The speaker 228 generates sound in response to receiving an audio signal from the control unit 200. Typically, the speaker 228 generates sounds that assist a user of the interface apparatus 100 in operating the interface apparatus or in operating the device 104 to which the interface apparatus is connected. For example, the speaker 228 produces sound from a text to speech function of the control unit, which converts the text of a user interface to audio. The speaker 228 is any speaker as desired by those ordinary skill in the art. In another embodiment, the speaker 228 is located on the right temple 120 or the bridge structure 128.

The tactile inputs 232 are exemplary I/0 devices that are supported on the support structure on the left temple 136 and are electrically coupled to the control unit 200. The tactile inputs 232 are electric switches that send an electronic signal to the control unit 200 when they are touched. The tactile inputs 232 are referred to as “soft buttons” since their function depends on the state of the display data displayed by the display screen 224. Accordingly, the processor of the control unit 200 is configured to execute the program instructions to configure a function of the tactile inputs 232 based upon the received interface data from the device 104. For example, in one state a tactile input 232 is used to select an option and in a second state the tactile input is used to turn off power to the device 104.

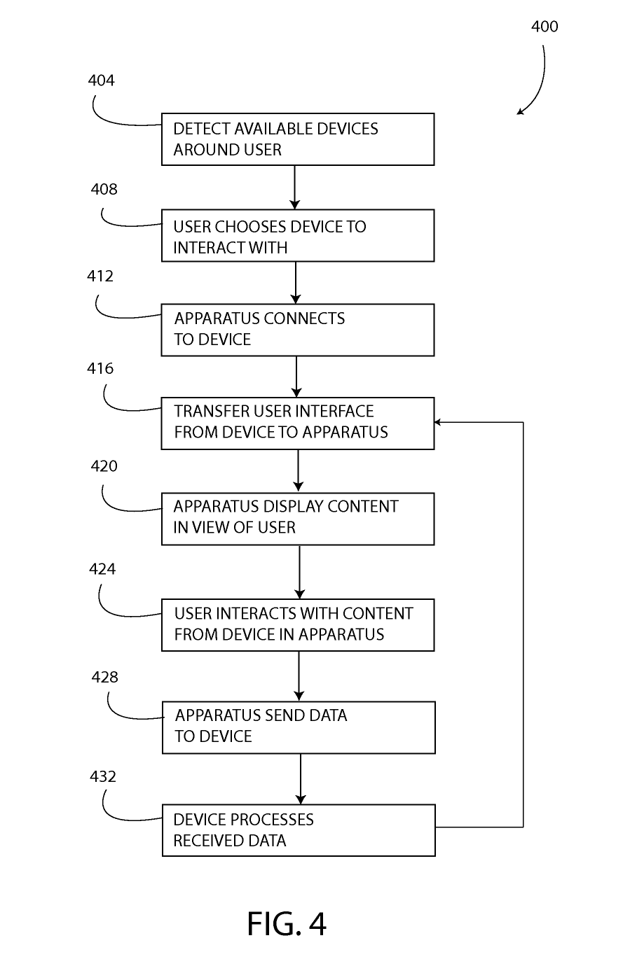

In operation, the interface apparatus 100, in one embodiment, performs the method 400 illustrated by the flowchart of FIG. 4. First, the user dons the interface apparatus 100 like a pair of eyeglasses or sunglasses. When the interface apparatus 100 is supported on the head of the user, the user's vision is not obstructed, and the user's surroundings are clearly visible through the lenses 124, 132.

To begin using the electronic features of the interface apparatus 100, the user energizes the apparatus by touching one of the tactile inputs 232, by speaking a voice command, by making a hand gesture, making a body gesture or other movement, or by simply moving to a particular location. When powered on the interface apparatus 100 wirelessly connects to a local area network, if one is available, using the transceiver 204. In another embodiment, the interface apparatus 100 connects to a cellular network, if one is available, using the transceiver 204. Alternatively, the interface apparatus 100 wireless connects directly to one or more of the configurable device 104 using a suitable wireless protocol.

As shown in block 404, once powered on, the interface apparatus 100 detects available devices 104 in the vicinity of the user using the transceiver 204, the location sensor 212, and/or the camera 220. The interface apparatus 100 uses the transceiver 204 to locate nearby devices 104 by listening for data packets associated with the devices. Alternatively, depending on the wireless communication protocol in use, the transceiver 204 broadcasts a data packet that instructs nearby devices 104 to respond with an identifying data packet.

By executing the program instructions, the interface apparatus 104 uses the location sensor 212 to locate nearby devices 104 by first determining the current position of the interface apparatus 100. Then the interface apparatus 100 compares its current position to a list of positions of the devices 104. Those devices 104 within a particular range, approximately fifty feet (50 ft.), for example, are considered nearby devices.

The interface apparatus 100 uses the camera 220 to locate nearby devices by processing the image data to determine if a barcode or other optical marker (such as a specific shape) has been captured by the camera. Specifically, the control unit 200 executes the program instructions to identify a portion of the image data that represents the barcode or other optical marker. The data contained in the barcode or optical marker is then cross-referenced against a list of devices 104 to determine, with which device 104 the barcode is associated, for example.

The interface apparatus 100 also uses the camera 220 to implement a shape recognition mode of operation. In this mode of operation, first a user touches a device 104 that is located in the field of view of the camera 220. Then the interface apparatus 100 compares the shape of the touched device 104 to a list of known shapes of devices. If the interface apparatus 100 recognizes the shape of the device 104, the device is added to the list of nearby devices.

After, using one or more of the above-described methods of determining the nearby devices 104, the interface apparatus 100 organizes the list of nearby devices 104. Specifically, the interface apparatus 100 determines an approximate distance of each device 104 from the interface apparatus and organizes the devices from near to far. Furthermore, the interface apparatus 100 determines which of the devices 104 are located in the user's field of view, using either the camera 220 or the location sensor 212 and/or the motion sensor 208.

Next, the interface apparatus 100 displays a listing of the nearby devices 104 on the display screen 224 or reads the listing of nearby devices using a text to speech function. The user is able to see his surrounding and is also able to see the GUI showing the listing of devices 104. In block 408, the user selects one of the devices 104 to connect to from the list of available devices. To make the selection, the user either presses one of the tactile inputs 232, speaks the name of the device 104, makes a particular hand/arm gesture or other movement that is visible to camera 220, touches one of the devices 104 that is within the field of view of the camera (or touches a particular part, a “hotspot,” of one of the devices), positions an optical marker of one of the devices 104 within the field of view of the camera, and/or moves his/her body in a particular way that is recognized by the motion sensor 208.

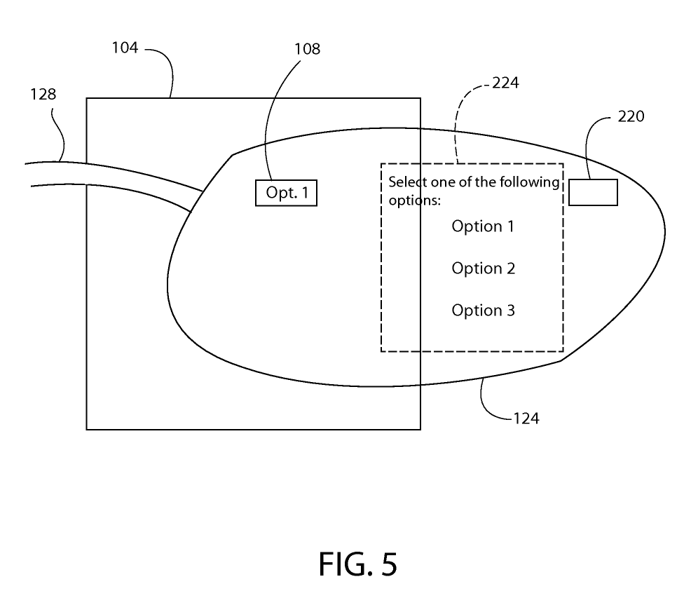

In block 412, the interface apparatus 100 establishes a communication link with the selected device 104 using, among other components, the processor of the control unit 200. As shown in FIG. 5, when the interface apparatus 100 connects to the device 104, interface data (including the current operating state of the device and the interface 108) is wirelessly transferred (i.e. extracted) to the interface apparatus from the configurable device 104. This transfer of data includes up to the entire interface data, including all of the options and selections that can be made with the interface 108. For this purpose, the device 104 has an interface program stored in a memory that is particularly suited for operation on the interface apparatus 100. Alternatively, the device 104 sends interface data that is optimized to a proper format for the display screen 224 by the interface apparatus 100.

As shown in block 420, after receiving the interface data through the communication link the interface apparatus 100 generates an alternative version of the interface data that is optimized for display on the display 224. After the interface data are optimized they are referred to herein as optimized display data.

Since the display screen 224 is capable of displaying many more characters than the interface 108, optimizing the interface data may include altering the data so that much more information is displayed at once on the display screen. For example, in FIG. 5 the device 104 has an interface 108 that is capable of displaying one line of text of approximately seven characters at once. Messages longer than seven characters are scrolled across a screen of the interface 108. The display screen 224 however, is configured to display multiple lines of text and each line has room for approximately twenty characters (depending on the size of the characters, which is configurable). Accordingly, optimizing the interface data may include formatting the interface data so that an entire menu tree structure is shown at once on the display 224. Alternatively, in other embodiments, optimizing the interface data may include simplifying a complex interface so that only selected portions of the interface data are shown on the display 224. After the optimized display data are generated the optimized display data are rendered on the display.

With reference to block 424, next, the user uses the interface apparatus 100 to interact with the interface 108 of the device 104. As shown in FIG. 5, this may include using the tactile inputs 232 to select one of the options displayed in the interactive dialog. After the interface apparatus 100 receives the user selection of the rendered optimized display data, the display screen 224 updates by displaying a submenu or additional options, as would occur if the user were operating the device 104 with the interface 108.

In blocks 428 and 432, after the user makes the user selection, the interface apparatus 100 transmits a control signal to the device 104 based upon the user selection. The device 104 causes the interface 108 to update and also may begin to perform one of its intended operations. If, for example, the device 104 is a microwave oven, after a cook time and a cook temperature are selected with the interface apparatus 100, the device beings a cooking operation.

After interacting with the device 104, the user is able to return to the listing of nearby devices (which is periodically updated) and connect to a different device. Interacting with the device 104 on the interface apparatus 100 is easier than using the interface 108 since much more information is displayed on the display screen 224 than is displayable on the interface 108. This makes navigating to submenus and viewing a list of options more convenient than viewing scrolling text on a one line display of the interface 108.

With the method 400 a user is able to switch between using the interface apparatus 100 to interact with the device 104 and using the interface 108 to interact with the device. This enables the user to begin interacting with a device 104 using the interface 108, and then switch to using the interface apparatus 100 to continue interacting with the device. The method 400 enables this operation, since the current state of the device 104 and the interface 108 (including any current inputs made by the user) are periodically sent to the interface apparatus 100. Additionally, both the interface 108 and the interface apparatus 100 are usable in parallel, with the user switching between the two on the fly and inputting some data into the interface 108 and other data into the interface apparatus 100.

In another embodiment, the interface apparatus 100 is used to simplify a complex user interface 108 of a device 104. For example, a device 104 includes a user interface 108 that has computer monitor and a keyboard. The computer monitor displays a command prompt and a list of approximately thirty options. The keyboard is typically used to type data into the command prompt and to select one of the options. When the interface apparatus 100 connects to the device 104, the apparatus 100 optimizes the interface data by simplifying the complex user interface 108 to just the five most relevant options, which are displayed on the display screen 224. The interface apparatus 100 determines the most relevant options using the location sensor 212, the motion sensor 208, and the current state of the device 104, among other things. Additionally, the interface apparatus 100 enables the user to enter data to the command prompt by speaking the data to be entered instead of having to use the keyboard.

In yet another embodiment, the interface apparatus 100 operates as a user interface to a device 104 that does not include a display. For example, some devices 104 for security reasons, among other reasons, are encased within a protective housing that hides the device from view and prevents damage to the device. When the interface apparatus 100 connects to such a device, it generates or receives data that correspond to a user interface for operating/controlling the device.

In one embodiment, the camera 220 and the motion sensor 208 are used to position the data displayed on the display screen 224 in a particular location. For example, the interface data of a particular device 104 are displayable on the display screen in a manner that makes it appear that the interface data are “attached” to a portion of the device. The interface data remain attached to the device 104 even if the user moves his/her head. Additionally, the interface apparatus 100 is able to “highlight” a particular button or switch on the device 104 that should be used to make the device perform an intended operation. The highlighted button or switch remains “attached” to the portion of the device, as described above. Alternatively, the interface apparatus 100 moves the interface data of a device 104 to a portion of the display screen 224 that enables the user to have a full view of the device without the interface data obstructing the device.

In a particular embodiment, the interface apparatus 100 simplifies operation of an exemplary microwave oven. When the interface apparatus 100 is not used, the following sequence of programing steps are used to prepare the microwave oven for a cooking operation:
Button on microwave: <Auto defrost>
Display on microwave: [Repeat]→[To]→[Select][Food]→ [symbol]
Button on microwave: <Auto defrost>
Display on microwave: [Ground]→[Meat]→[Enter]→[Weight]→ [symbol]
Button on microwave: <Auto defrost>
Display on microwave: Steaks→[Chops]→[Enter]→[Weight]→ [symbol]
Button on microwave: <Auto defrost>
Display on microwave: [Bone-]→[in Poultry]→[Enter]→[Enter]→[Weight]→ [symbol]
Button on microwave: <Auto defrost>
Display on microwave: [Roast]→[Enter]→[Weight]→ [symbol]
Button on microwave: <Auto defrost>
Display on microwave: [Casse-]→[role]→[Enter]→[Weight]→ [symbol]
Button on microwave: <Auto defrost>
Display on microwave: [Soup]→[Enter]→[Number]→[Cups]→ [symbol]
Button on microwave: <1>
Display on microwave: [1 Cup]→[Press]→[Start]→ [symbol]
Button on microwave: <Start>

Using the interface apparatus 100, the same dialog is much simpler and shorter and is done with multimodal input using wearable glasses and hand gestures according to the following sequence of events:
Button on microwave: <Auto defrost>
Display in glasses:
   Select Food
      1. Ground Meat
      2. Steaks Chops
      3. Bone-in Poultry
      4. Roast
      5. Casserole
      6. Soup
         At this point, the user of the interface apparatus 100 makes a swipe gesture with his/her hand to select item 6. The swipe gesture is captured in the image data generated by the camera 220, and the processor of the control unit 200 executes the program instructions to optimize the display data based upon the type of gesture made by the user. Of course, the user could alternatively have used one of the tactile inputs 232 to make the selection, or used the voice input operation. Next, the display screen 224 displays “How many cups?,” at which points the user states “one.” After processing the user's speech the display screen shows “1 cup.” Next the user presses the <Start> button on the microwave to begin the cooking operation. The <Start> button on the microwave is an example of an I/O device supported by the configurable device 104 that is configured to accept a user selection of the optimized display data displayed by the user interface device 100. After the <Start> button is pressed the device 104 transfers a control signal to the user interface apparatus 100 that is based on the selection received by the I/O device supported by the configurable device 104. In the exemplary embedment, the control signal may include data indicating that a cooking operation has been initiated.

In addition to the exemplary devices 104 described above, the interface apparatus 100 is also useable with devices for home health care, robotics, diagnosis systems, heating ventilation and air conditioning (“HVAC”), control, printers, vehicle satellite navigation systems, and entertainment systems. Additionally, the interface apparatus 100 is usable with home appliances, security panels, stationary telephones, multimedia players, and vehicle radios.

In another embodiment, at least the display screen 224 of the interface apparatus 100 is connected to a contact lens (not shown), which projects images toward the retina of the user's eye. The contact lens(es) are configured for wireless communication with the control unit 200. In this embodiment, the control unit 200 and other components are provided in a housing that a user may carry in a pants or shirt pocket instead of having to wear the glasses assembly described above.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A user interface apparatus comprising:
a support structure configured to be supported on the head of a user;
a display supported by the support structure;
a memory supported by the support structure and including program instructions; and
a processor supported by the support structure and operably connected to the display and to the memory, the processor configured to execute the program instructions to
establish a communication link with a configurable device,
receive interface data from the configurable device,
generate optimized display data using the received interface data,
render the optimized display data on the display,
receive a user selection of the rendered optimized display data, and
transmit a control signal to the configurable device based upon the received user selection.

2. The user interface apparatus of claim 1, wherein the support structure includes:
a first lens;
a first temple pivotably coupled to the first lens;
a bridge structure fixedly connected to the first lens;
a second lens fixedly connected to the bridge structure; and
a second temple pivotably coupled to the second lens,
wherein the display is located on one of the left lens and the right lens.

3. The user interface apparatus of claim 1, further comprising:
a location sensor supported by the support structure,
wherein the processor is further configured to execute the program instructions to determine a location of the user interface apparatus using the location sensor.

4. The user interface apparatus of claim 1, further comprising:
a motion sensor supported by the support structure,
wherein the processor is further configured to execute the program instructions to determine an orientation of the user interface apparatus in three dimensional space using the motion sensor.

5. The user interface apparatus of claim 1, further comprising:
a camera supported by the support structure and configured to generate image data within a field of view of the camera,
wherein the processor is further configured to execute the program instructions to identify a portion of the image data representing an optical marker positioned within the field of view.

6. The user interface apparatus of claim 1, further comprising:
a camera supported by the support structure,
wherein the processor is further configured to execute the program instructions (i) to generate image data within a field of view of the camera, and (ii) to generate the optimized display data based upon a portion of the image data representing a gesture made by the user within the field of the view.

7. The user interface apparatus of claim 1, further comprising:
a tactile input supported by the support structure,
wherein the processor is further configured to execute the program instructions to configure a function of the tactile input.

8. The user interface apparatus of claim 1, further comprising:
a microphone supported by the support structure,
wherein the processor is further configured to execute the program instructions to detect a selected sound using the microphone.

9. A method of configuring a device comprising:
supporting a user interface apparatus on the head of a user;
establishing a communication link with a configurable device using a processor supported by the user interface apparatus;
receiving through the communications link interface data from the configurable device;
generating optimized display data with the processor using the received interface data;
rendering the optimized display data on the display;
receiving with an I/O device supported by the user interface apparatus a user selection of the rendered optimized display data; and
transmitting a control signal to the configurable device from the user interface apparatus based upon the received user selection.

10. The method of claim 9, further comprising:
selecting the configurable device from a plurality of configurable devices detected by the user interface apparatus.

11. The method of claim 10, further comprising:
displaying a list of the plurality of configurable device on the display.

12. The method of claim 10, wherein the selecting the configurable device comprises:
touching the configurable device when the configurable device is within a field of view of a camera supported by the user interface apparatus.

13. The method of claim 10, wherein the selecting the configurable device comprises:
positioning an optical marker of the configurable device within a field of view of a camera supported by the user interface apparatus.

14. The method of claim 9, wherein the user selection is a first user selection and the method further comprises:
receiving with an I/O device supported by the configurable device a second user selection of the rendered optimized display data; and
transmitting an interface control signal to the user interface apparatus from the configurable device based upon the received second user selection.

15. The method of claim 9, wherein receiving with an I/O device supported by the user interface apparatus a user selection comprises:
detecting a selected movement of the user with a camera supported by the user interface apparatus.

16. The method of claim 9, wherein receiving with an I/O device supported by the user interface apparatus a user selection comprises:
detecting a selected location with a location sensor supported by the user interface apparatus.

17. The method of claim 16, wherein the location sensor is configured to determine a location of the user interface apparatus using a global positioning system.

18. The method of claim 9, wherein receiving with an I/O device supported by the user interface apparatus a user selection comprises:
detecting a selected sound with a microphone supported by the user interface apparatus.

19. The method of claim 9, further comprising:
configuring a function of a tactile input supported by the user interface apparatus based upon the received interface data.

20. The method of claim 9, further comprising:
displaying the interface data on a display of the configurable device.
